(19) United States
(12) Patent Application Publication
(10) Pub. No.: US 2017/0291656 A1
(43) Pub. Date: Oct. 12, 2017

(54) BICYCLE TRAILER WITH INTEGRATED LIGHTING

(71) Applicant: Croozer GmbH, Köln (DE)

(72) Inventors: Fabien Yannick Schmitt, London (GB); Nigel Timothy Court, London (GB); Marko Plevnik, London (GB); Graham Keith Lacy, London (GB)

(21) Appl. No.: 15/506,170

(22) PCT Filed: Aug. 25, 2015
(86) PCT No.: PCT/EP2015/069467

§ 371 Date: Feb. 23, 2017

(30) Foreign Application Priority Data
Aug. 26, 2014 (DE) 10 2014 112 248.8

(51) Int. Cl. B62J 6/00; B62K 27/00; B62K 27/12; B62B 7/12

(52) U.S. Cl. CPC B62J 6/003; B62B 7/126; B62K 27/003; B62K 27/12; B62K 2208/00

(57) ABSTRACT

The invention relates to a bicycle trailer, in particular for transporting children, comprising a chassis (1, 23) and a frame which is connected to the chassis for a passenger compartment. The trailer has at least two wheels (2, 21) and can be provided with a towbar (3, 22) for hitching to a bicycle and at least one third wheel in order to use the bicycle trailer as a stroller or as a jogger. The trailer has a lighting device (14, 35) and a push handle (6, 25). The aim of the invention is to provide such a bicycle trailer in which the handling of the lighting device is simplified. According to the invention, this is achieved in that at least one lighting device is integrated into the push handle or into a coupling for securing the push handle to the frame.

The present invention relates to a bicycle trailer, in particular for transporting children, comprising a chassis and a frame, which is connected to the chassis, for a passenger compartment. The trailer has at least two wheels and can be provided with a towbar for hitching to a bicycle and with at least a third wheel in order to use the bicycle trailer as a stroller or as a jogger. The trailer has a lighting device and a push handle.

Multi-function bicycle trailers for transporting children are known. As a rule, they offer the option of connecting the bicycle trailer in its main function as bicycle trailer to a drawing vehicle, in particular a bicycle, by means of a towbar. In order to use a multi-function bicycle trailer as a stroller or as a jogger, or generally speaking, as a push vehicle, the towbar can either be removed or folded away such that it no longer interferes with the vehicle. Moreover, one or two additional wheels can be attached to the chassis in addition to the already existing two wheels, such that the vehicle can travel independently on three or four wheels. The multi-function bicycle trailer can then be pushed by means of a push handle, which is generally connected to upper side sections of the frame as a U-shaped bar. The frame is generally configured such that the passenger compartment can be folded to a small extent over the chassis in order that the bicycle trailer can be transported in the boot of a car, for example.

There are various embodiments for the push handles. In a known embodiment, the push handle is configured as a U-shaped bar, wherein the free ends thereof can be inserted into open tube ends on the upper frame and fixed therein (for example, in the case of Croozer® bicycle trailers that are currently available). In the case of other multi-function bicycle trailers known in the market, for example those made by Burley, the push handle is also configured as a U-shaped bar, the free ends of which are connected to the upper section of the frame via a swivel joint such that for pushing into a position behind the passenger compartment, and in the event that it is not required, the bracket can be brought into a position on the passenger compartment and fixed in the respective position. In a further already known embodiment, the push handle is attached to substantially vertical or horizontal sections of the frame of the passenger compartment of the bicycle trailer using clamping devices.

A battery-operated light is available for Burley multi-function bicycle trailers, which can be clipped onto a fixed adapter on an upper transverse rod of the frame. The skin of the passenger compartment has an opening at the position of the adapter for this purpose. The light has a front white light and a rear red light. Although the light is easy to see in its mounted state, it increases the aerodynamic resistance of the bicycle trailer and is inconvenient when folding up the passenger compartment. It is also prone to impact when folding up the passenger compartment. If the light is removed from the passenger compartment, it has to be taken along as a separate small part and is easy to lose. All these factors make the using of the light difficult.

To increase the operating safety of bicycle trailers, it is known from DE 20 2004 014 717 U1, for example, to furnish the bicycle trailer with a pennant pole on the top of which a light is arranged. However, pennant poles generally have the disadvantage that they are awkwardly shaped and in most cases have a certain elasticity, which is why they sway backwards and forwards during travel thereby putting other road users, in particular pedestrians, at risk. This applies all the more if the weight of a light is applied to the end of the pennant pole.

In contrast to this, an object of the present invention is to provide a bicycle trailer in which use of the lighting device is simplified.

This object is achieved with a bicycle trailer of the type referred to at the start having the features of claim 1 in that at least one lighting device is integrated into the push handle or into a coupling for securing the push handle to the frame.

The basic concept of the invention consists accordingly in integrating the lighting device into the push handle or into the coupling for attachment thereof.

A push handle is not only understood here and in the following simply as a substantially U-shaped bar. The invention can also be applied to multi-function trailers in which a right and a left push handle are provided as separate components.

‘Integrate’ is understood here and below to mean that the housing of the lighting device is inserted at least partially into the push handle or into a coupling to attach the push handle to the frame and/or rests at least partially directly on the push handle and surrounds the latter at least partially such that the lighting device is attached to the push handle in a form-fit manner and firmly in position. ‘Firmly in position’ is understood here to mean that the position and angle of reflective beam of the lighting device relative to the push handle is clearly defined and cannot be changed.

Light diodes are suitable in particular as light sources for the lighting device, but naturally, light bulbs can also be used.

Integrating the lighting means as part of the push handle or the coupling for attaching the push handle simplifies use, firstly in that the lighting device is no longer an additional accessory on the multi-function bicycle trailer but part of a functional component which is not directly part of the passenger compartment. This allows an arrangement of the lighting device on the multi-function bicycle trailer where the lighting device no longer interferes when the passenger compartment is folded down and a risk of impact is at least reduced.

Notwithstanding the above, the lighting device is arranged at the height of the push handle, i.e. on top of the multi-function trailer and is thus generally well clearly visible. Moreover, it is not necessary to provide an opening in the skin of the passenger compartment for attaching the lighting device. Thus, a mechanical weak point in the skin of the passenger compartment can be avoided and leakages are prevented.

Finally, the lighting device cannot slip due to it being held firmly in position such that the angle of reflected beam of the lighting device is always clearly defined.

If the lighting device is integrated into a removable push handle, then the lighting means can be removed from the multi-function bicycle trailer together with the push handle. Since the push handle is significantly larger than a light, the lighting means are not so easily lost especially as they are not an additional part of the multi-function bicycle trailer.

If the push handle is configured as a bar, the lighting device can extend a comparatively long distance in the longitudinal direction of the bar, where required over the entire length thereof. Illuminated surfaces with lengths of 15 or 25 cm or even significantly longer can be easily realised. The push handle can have a recess on one side of its profile for this purpose, for example, into which a part of the housing of the lighting device is inserted and in which the housing is held, for example, by a screw connection or a simple catch mechanism, which can also be configured as a detachable catch mechanism if required.

In the push handle configured as a bar, the lighting device can be arranged on the central, rear section of the bar in the direction of travel. It is possible in this case to configure the lighting device along the bar to increase the visibility.

In an advantageous embodiment, at least one lighting device is provided on each free arm of a U-shaped push bar. Moreover, it is advantageous in this case if the lighting device completely surrounds the profile of the push handle and/or protrudes at least partially over the profile cross-section of the push handle. The side arrangement means that the width of the passenger compartment can be marked with lighting means in the dark, in particular if the lighting device protrudes outwards at least partially on the side beyond the profile of the push handle.

The lighting device can also be drawn around the corners of the push bar. This has the advantage that with two lighting means, both side and rear lighting of the bicycle trailer is possible, which increases the visibility from the sides and from behind, wherein the width of the passenger compartment is marked at the same time.

If the housing of the lighting device surrounds the profile of the push handle, form fitting can be achieved by providing positioning pins in the housing for example, which engage in holes provided for this purpose in the profile of the push handle. The housing can also be screwed tightly to the push handle.

As an alternative, fixed positioning can also be achieved such that the push handle has a non-circular cross section profile at least in the region of the position of the lighting device and such that the housing, for example in the form of two housing shells, has contact surfaces, which correspond to the shape of the non-circular cross section profile. Moreover, cross section extensions can be provided on the push handle, which define the position of the lighting device. Alternatively, it is sufficient if, for example, an at least partially circumferential groove is set into the push handle on the outside into which a strip provided inside the housing engages.

The translucent part of the lighting means (diffusion disc) can be passed around the profile cross section as a light surface completely or almost completely such that the visibility of the lighting device is improved further. This is not only the case if the housing of the lighting device surrounds the push handle, but also if a part of the housing is inserted into the profile of the push handle. In both cases, it is not absolutely essential that the illuminated surface of the light source is completely illuminated by the light source in the lighting device. Parts of the illuminated surface or even the entire illuminated surface can be configured as light conductors, into which light is fed in one or several places and from which the light is dispensed substantially evenly over the surface.

The housing of the lighting device can also serve as a grab handle close to the free ends of a removable push bar, for example, to simplify the handling of the bar during attachment to the bicycle trailer. The lighting device can be partially encased with a soft foam or silicone material for this purpose, which, if it also extends over the illuminated surfaces of the lighting device, is translucent at least in those places.

The housing of the lighting device can also be configured such that a part containing the light source and, where applicable, also a power source (for example, battery), is detachably useable, wherein the lights and the housing are connected to each other via a quick-release fastener, for example a detachable catch mechanism.

In a further preferred embodiment of the invention, lighting devices are integrated into the outsides of lockable swivel joints, which either sit in the two free arms of a push bar or act as coupling for attaching the push handle to the frame. Preferably, the lighting devices are attached to the fixed part of the swivel joint here such that the position of the lighting device is fixed in relation to the bicycle trailer.

The lighting device can be easily provided with power via a battery or a rechargeable battery. A recess can be provided for the battery, for example, which sits in a part of the housing, in an exception set into a profile, preferably hollow profile, of the push handle, or into the coupling configured as a lockable swivel joint. The housing can then, for example, be releasably locked into the recess via a snap lug accessible from the outside such that it can be taken out of the recess in order to change the battery.

In one solution, which is more complex in terms of its design, but more convenient for the user, power leads are provided inside the frame or on the frame to connect the lighting device(s) to a power source. If the one or more lighting devices sit in the push handle, these are supplied with power via conductors running along the profile of the push handle. The conductors are coupled to the power leads inside the frame. Particularly in the case of a plug-in coupling for plugging the push handle into or onto retainers on the frame, preferably a contacting device is provided in the coupling for this purpose by means of which the conductors running along or inside the profile of the push handle can be electrically connected to corresponding conductors in the frame.

The lighting device preferably emits different coloured lights to the front in the direction of travel and to the rear. This can be achieved by one light source per lighting device in that the lighting means has a translucent cap coloured in one colour or a clear cap in the front part in the direction of travel, and has a different translucent coloured, for example red, cap in the rear part in the direction of travel. Each lighting means can also have a part radiating forwards and backwards, which is fitted with different coloured light sources for example. LED lights are particularly suitable as light sources. If multi-coloured LEDs are used as light sources, it would be possible to change the colour radiated as required. For instance, a yellow flashing light can be easily generated to indicate a change of direction.

An individual power source is suitable as the power source for the lighting device, in particular one or more batteries or rechargeable batteries. Preferably, the batteries or rechargeable batteries can be accommodated inside the housing of the lighting device but also outside the housing on the push handle or on the bicycle trailer, where appropriate, in a housing provided for this purpose. If rechargeable batteries are used as the power source, the lighting device can have a charge socket, for example, a standard mini USB connection. One or more solar cells can also be provided on the lighting device or bicycle trailer or push handle for charging rechargeable batteries. If several lighting devices are used on the bicycle trailer, it is sufficient if one of the lighting devices has its own power source and the other draws power from this one power source by being wired for this. Several lighting devices can also be wired together such that a charge socket on a lighting device also supplies the rechargeable battery or batteries in the other lighting device(s).

As an alternative or in addition to an individual power source, external power sources can also be used to supply energy to the lighting device(s), such as a generator on the bicycle trailer, a wheel rim generator or a hub generator, for example, or a power supply via the bicycle pulling the trailer (for example, dynamo) or electric bicycle.

Another preferred embodiment of the invention is characterised by an activation device wirelessly connected to the lighting device for controlling the operation of the lighting device. A wireless remote control that can be fitted to the handlebars of a bicycle can be used as an activation device, for example, with which the lighting device(s) can be switched on and off and, where appropriate, also other lighting modes, for example, right or left indicators or warning indicators can be switched on and off.

Similarly, the above-mentioned object can also be achieved in a bicycle trailer of the type referred to at the start, in which at least part of the lighting device is arranged on the outer side on a section of the bicycle trailer and the lighting device is attached in particular on an outside of a side part of the frame or integrated into it. This makes it possible to clearly mark the maximum width of the passenger compartment in the dark.

Various aspects of the invention are described below with the help of drawings in which:

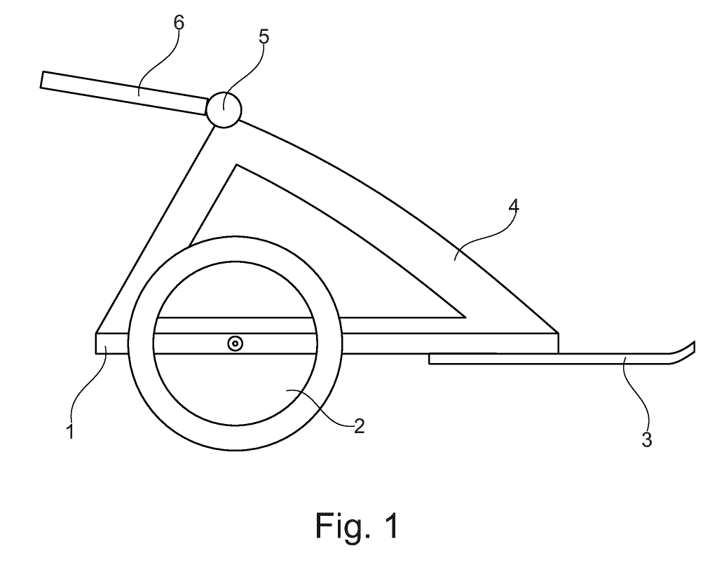

FIG. 1 shows a simplified view of a multi-function bicycle trailer;

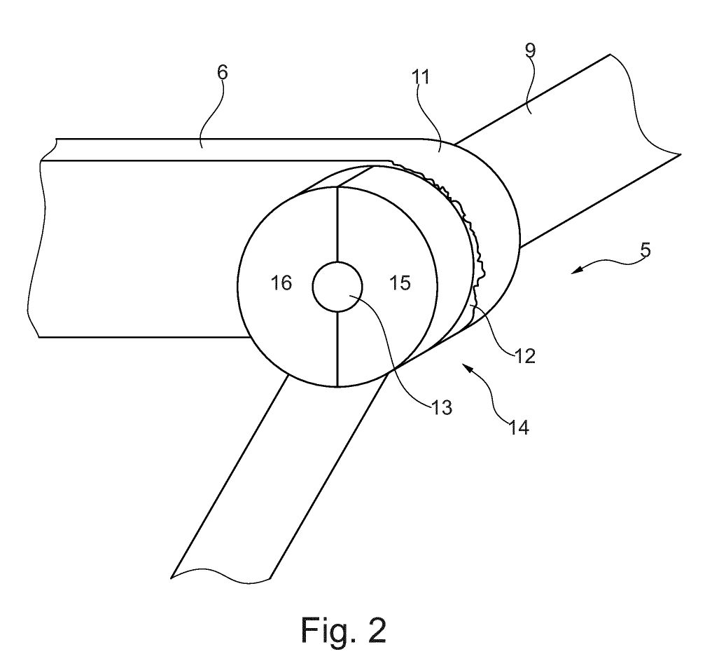

FIG. 2 shows a lighting device integrated into the swivel joint for attaching the push handle to the bicycle trailer from FIG. 1;

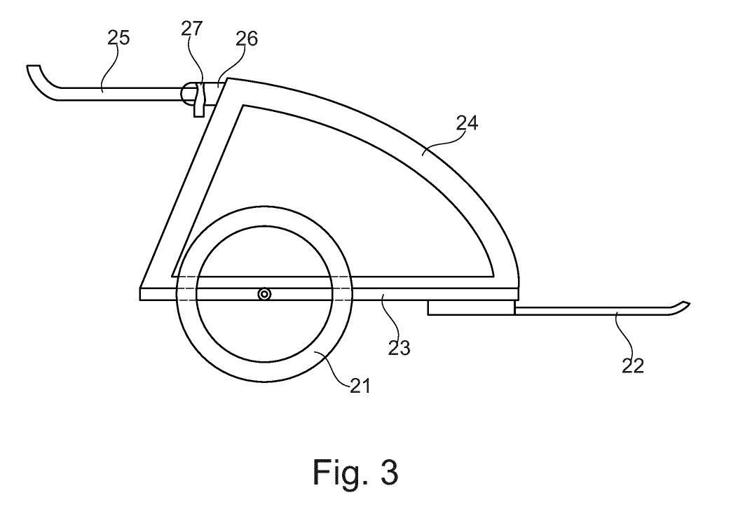

FIG. 3 shows a simplified view of another multi-function bicycle trailer; and

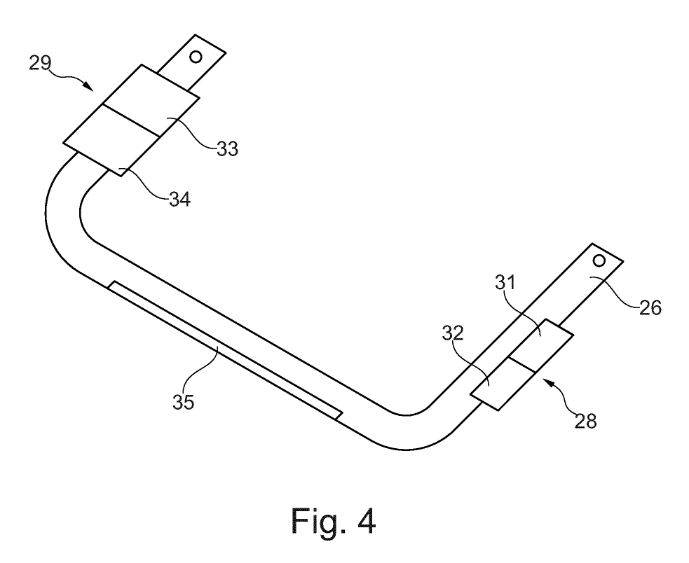

FIG. 4 shows a push handle according to the invention with various examples of lighting devices integrated therein.

The multi-function bicycle trailer show in simplified form in FIG. 1 has a chassis 1 onto which the wheels 2 are hung and to which the towbar 3 is attached and which supports the passenger compartment, which is formed inter alia by a frame and an external skin 4 stretched over said frame. A lockable swivel joint 5 is attached at the top of the frame on which a push handle 6 is hinged.

FIG. 2 shows an exemplary embodiment according to the invention of a lighting means configured on the swivel joint 5. The swivel joint 5 has a rotating part 11, to which the push handle 6 is attached as well as a fixed part 12. The fixed part 12 is firmly attached to a tube 9 of the frame that runs transversely. The parts 11, 12 are pressed against each other via an internal spring mechanism such that both parts are fixed relative to each other based on a tooth structure on the side of both parts facing each other. The engagement of the parts 11, 12 with each other can be released by pressing a button 13. A lighting device 14 is integrated into the fixed part 12 of the swivel joint. In this case, the outer cap of the fixed part 12 is formed by a translucent cover with a white front section 15 and a red rear section 16, which enables both lateral and radial radiation of light. A light source (not shown here) and a reflector sit underneath the translucent cover.

Expediently, such lighting means is integrated into the swivel joints on both sides of the bicycle carrier. In an alternative design (not shown), the translucent cover can also protrude over the circular cross section of the swivel joint, for example, upwards in a rod shape, such that the radiating surface is increased.

FIG. 3 shows a similar bicycle trailer with a chassis 23, which supports the wheels 21, the towbar 22 and the passenger compartment. The passenger compartment is formed inter alia by a frame and an external skin 24 stretched over said frame.

Unlike the bicycle trailer in FIG. 1, the push handle 25 here is inserted into tubular recesses 26 and locked into place using a lock pin 27, for example.

FIG. 4 shows various options for integrating a lighting means according to the invention into the push handle 25 of the bicycle trailer shown in FIG. 3. Naturally, the lighting means can also be integrated in the same way into the push handle 6 of the bicycle trailer in FIG. 1.

The U-shaped push handle has a lighting means 28, 29 in each of the side arms. As in the example of the lighting means 28, the lighting means here can be inserted from the outside into a recess in the profile of the push handle and stand proud from the profile on the side. As an alternative, as shown in the case of lighting means 29, the lighting means can completely surround the profile of the push handle or at least almost completely. The translucent, light-emitting part of the lighting means can have a profile adjusted accordingly for this purpose, which is either pushed axially onto the free arm of the U-shaped push handle or, in the case of partial surrounding of the light source, clipped onto the profile of the push handle. A section of the light source, for example a battery housing, can also be embedded into a recess in the profile of the push handle.

A third option consists of arranging the lighting device 35 on the rear section of the push handle such that it radiates to the rear. It is sufficient in this case if the diffusion disc of the light is configured as monochrome red. If the lighting device stands proud from the profile of the push handle, the lighting device can also radiate light to the side. As already stated above, but not shown here, a fourth option consists of guiding the lighting device around the corners of the push handle such that light is also radiated to the rear and the side in this embodiment.

1. A bicycle trailer for transporting children, comprising:
a chassis and an associated frame for a passenger compartment, which comprises at least two wheels and configured to provided with a towbar for attachment to a bicycle, and configured to be provided with at least a third wheel for using the bicycle trailer as a stroller or jogger,
wherein the bicycle trailer further comprises a lighting device and a push handle, wherein the at least one lighting device is integrated into the push handle or into a coupling for attaching the push handle to the frame.

2. The bicycle trailer according to claim 1, wherein the push handle is configured as a substantially U-shaped bar and
the at least one lighting device is provided on a section of the bar connecting two free arms running transverse to the direction of travel, and/or
the at least one lighting device is provided on each free arm of the bar, and/or
one lighting device or a lighting device in each case is drawn around rear corners of the bar.

3. The bicycle trailer according to claim 2, wherein the housing of the lighting device surrounds the push handle.

4. The bicycle trailer according to claim 2, wherein the lighting device protrudes at least partially over a profile cross section of the push handle.

5. The bicycle trailer according to claim 2, wherein a section of the housing of the lighting device is inserted into one or more recesses in a profile of the push handle.

6. The bicycle trailer according to claim 2, wherein the lighting device has a length of at least 15 cm.

7. The bicycle trailer according to claim 1, wherein the lighting device is encased completely or partially in a soft foam or silicone material.

8. The bicycle trailer according to claim 1, wherein the lighting device has a light source and a part containing a power source, which is releasably inserted into the housing of the lighting device.

9. The bicycle trailer according to claim 1, wherein the push handle is attached to the frame via at least one coupling configured as a lockable swivel joint wherein the lighting device is inserted into the swivel joint, wherein the lighting device is firmly attached to a fixed part of the swivel joint.

10. The bicycle trailer according to claim 1, wherein the lighting device has a recess in the housing thereof for a battery or a rechargeable battery.

11. The bicycle trailer according to claim 1, further comprising power leads inside the frame configured to connect the lighting device to a power source.

12. The bicycle trailer according to claim 1, wherein the lighting device is supplied with power via conductors running on or in the profile of the push handle.

13. The bicycle trailer according to claim 12, wherein a contacting device is provided in the coupling via which the conductors running on or in the profile of the push handle can be electrically connected to corresponding conductors in the frame, wherein the coupling is in particular a plug-in coupling for plugging the push handle into or onto holding fixtures in the frame.

14. The bicycle trailer according to claim 1, wherein the push handle has a lockable swivel joint in the two free arms thereof or the coupling for attaching the push handle to the frame is configured as a swivel joint, and that the lighting device is integrated into the swivel joint.

15. The bicycle trailer according to claim 1, wherein the lighting device emits different colored light to the front and to the rear according to the direction of travel.

16. The bicycle trailer according to claim 1, further comprising a generator connected to the lighting device.

17. The bicycle trailer according to claim 1, further comprising a rechargeable battery, which can be charged in particular by solar cells arranged on the bicycle trailer, the push handle or the lighting device.

18. The bicycle trailer according to claim 1, further comprising an activation device wirelessly connected to the lighting device for controlling the operation of the lighting device.
